(19) United States
(12) Patent Application Publication
(10) Pub. No.: US 2013/0063429 A1
(43) Pub. Date: Mar. 14, 2013

(54) SYSTEM AND METHOD FOR DISTRIBUTING THREE-DIMENSIONAL VIRTUAL WORLD DATA

(71) Applicant: Parham Sina, Rockville, MD (US)

(72) Inventor: Parham Sina, Rockville, MD (US)

(21) Appl. No.: 13/606,421

(22) Filed: Sep. 7, 2012

Related U.S. Application Data
(60) Provisional application No. 61/532,097, filed on Sep. 8, 2011.

(51) Int. Cl. G06T 15/00

(52) U.S. Cl. 345/419

(57) ABSTRACT

A system for delivering three-dimensional virtual content to a user. The system can include a three-dimensional virtual world hosted by a three-dimensional virtual world host, a client associated with a virtual plot of land within the three-dimensional virtual world, and a referencing database hosted by the three-dimensional virtual world host. A user can request three-dimensional virtual content relating to the virtual plot of land from the three-dimensional virtual world host, the three-dimensional virtual world host can respond by supplying the user with identifier data from the referencing database for the client associated with the virtual plot of land, the user can contact the client using the identifier data and request the three-dimensional virtual content, and the client can transmit the requested three-dimensional virtual content to the user.

### RELATED APPLICATIONS

This application claims priority, under 35 U.S.C. § 119(e), to U.S. Provisional Patent Application No. 61/532,097, filed Sep. 8, 2011, entitled “System for Distributing Computer 3D World Data” the disclosure of which is incorporated by reference herein in its entirety.

### BACKGROUND

It is known in the art that three-dimensional virtual worlds exist as a form of communication, commerce, and/or entertainment, among other forms, on the Internet or in other networks. Linden Lab's Second Life, for example, is a three-dimensional virtual worlds program which hosts three-dimensional virtual content for customer-leased plots of virtual land. Host businesses of three-dimensional virtual worlds, like Linden Lab, need to store large amounts of three-dimensional virtual content on their own servers so as to be downloaded by the computers of users that connect to their hosted three-dimensional virtual worlds.

This places a burden of large data storage and transmission requirements on these three-dimensional virtual world hosts and their networks, respectively. Also, a three-dimensional virtual world host or its administrators may be responsible for maintaining and/or updating its clients' three-dimensional virtual content. As well, a three-dimensional virtual world host's clients would cause its network to receive network traffic when uploading or updating their respective three-dimensional virtual content.

### SUMMARY

Generally, exemplary embodiments of a system and method for distributing three-dimensional virtual world data are disclosed. This system for distributing computer three-dimensional virtual world data can reduce the data storage requirement of a computer system hosting a three-dimensional virtual world.

This system can reduce the amount of network traffic between a three-dimensional virtual world host and its users and clients, and can relieve a three-dimensional virtual world host from the responsibilities of maintaining and updating its clients' three-dimensional virtual content. This system can also relieve a three-dimensional virtual world client from having to update his, her, or its three-dimensional virtual content remotely, or having to upload such three-dimensional virtual content to his, her, or its three-dimensional virtual world host.

This system for distributing computer three-dimensional virtual world data can relieve a three-dimensional virtual world host from having to store its clients' three-dimensional virtual content and transmit it to users who connect to its three-dimensional virtual world. In some exemplary embodiments, the system can do this by storing the three-dimensional virtual content relating to the user on the respective client's computer system. In these embodiments, when users connect to a three-dimensional virtual world, they can access three-dimensional virtual content associated with particular plots of virtual land. When they do so, at least some of the three-dimensional virtual content associated with a particular plot of virtual land may be hosted by, and thereby downloaded from, its respective client's computer system instead of the three-dimensional virtual world host itself.

In this way, three-dimensional virtual world clients can update their own three-dimensional virtual content locally, not needing to upload their three-dimensional virtual content to the three-dimensional virtual world host, thereby reducing traffic on the network used by the host of the three-dimensional virtual world, and relieving the host of the three-dimensional virtual world from the responsibilities of maintaining and updating those clients' three-dimensional virtual content.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 shows an exemplary embodiment of a process for distributing three-dimensional virtual content.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage, or mode of operation.

The term “user” refers to any human or computer connecting to a three-dimensional virtual world via a computer network (public or private network, including the Internet).

The term “computer system” refers to one or more computers serving a particular purpose, such as that of a server, client, or user. A computer system that stores three-dimensional virtual content can store such data on some type of storage medium, such as a solid state drive, hard drive, drive array, storage area network, or network-attached storage, and that three-dimensional virtual content can be accessible for downloading (and thereby accessing) by users.

The term “host” refers to a computer system to which users or clients connect.

The term “three-dimensional virtual world” refers to a digital virtual world made up of three-dimensional (and possibly including two-dimensional) graphical data (three-dimensional virtual content), where users can access its three-dimensional virtual space, including accessing plots of virtual land assigned to clients.

The term “three-dimensional virtual world host” refers to a computer system that hosts a three-dimensional virtual world where plots of virtual land are assigned to clients, and users can connect to that three-dimensional virtual world in order to access plots of virtual land and their respective three-dimensional virtual content.

The term “client” refers to any human or computer having been assigned a plot of virtual land in a three-dimensional virtual world. For example, a client could be a customer of a three-dimensional virtual world host business who leases a plot of virtual land in that business' three-dimensional virtual world. Users connected to the three-dimensional virtual world can access clients' plots of virtual land and their respective three-dimensional virtual content.

The term “three-dimensional virtual content” refers to three-dimensional virtual world graphical data related to the makeup of a three-dimensional virtual world's three-dimensional, and possibly including two-dimensional, images. This can include geometric models (shapes) and any associated model property such as color, material, texture, opacity, and reflectiveness.

Generally, to reduce the limitations of three-dimensional virtual world hosting, a system for distributing three-dimensional virtual content to clients' computer systems can be employed. Instead of three-dimensional virtual content being hosted by the three-dimensional virtual world host, three-dimensional virtual content can be hosted by the respective client computer system assigned or otherwise related to the plot of virtual land. The three-dimensional virtual world host can host a referencing database containing a correlation of the identifier for the client's plot of virtual land with that client's network or Internet identifier. As an example, the referencing database can store a correlation between the grid coordinates of a plot of virtual land and the public or private Internet Protocol (IP) address of the client computer system associated with the plot of virtual land. A client computer system can host and locally manage its respective three-dimensional virtual content.

In some exemplary embodiments, when a user connects to the three-dimensional virtual world, rather than download the three-dimensional virtual content from the three-dimensional virtual world host, that user's computer system can reference the referencing database so as to determine the network or Internet location of the client computer system which hosts the three-dimensional virtual content for the particular plot of virtual land being accessed by that user. After the user's computer system determines the client computer system's location, it can establish a connection with, and then download the relative three-dimensional virtual content from, that client computer system.

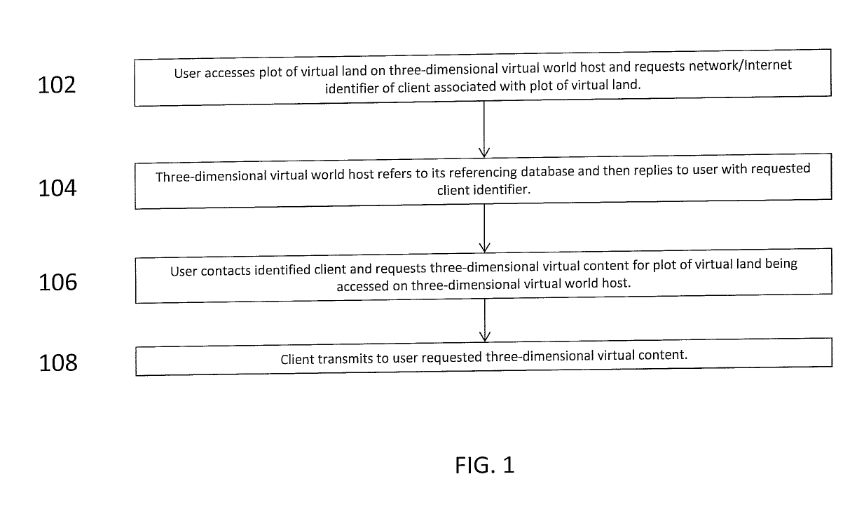

FIG. 1 shows an exemplary embodiment of a process for obtaining three-dimensional virtual content. At step 102, a user can access a virtual plot of land and request the network or Internet identifier of the client associated with the virtual plot of land. At step 104, the host of the three-dimensional virtual world can refer to its referencing database and reply to the user with the requested client identifier. At step 106, the user can use the identifier to contact the identified client and request three-dimensional virtual content for the desired plot of virtual land. At step 108, the client can transmit the requested three-dimensional virtual content to the user.

In some exemplary embodiments, the referencing database data, in part or whole, may be locally cached or otherwise stored on the user's computer system in order to further reduce network traffic on the three-dimensional virtual world host's network. In these embodiments, the user's computer system can determine the network or Internet locations of the client computer systems based on the cached data.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for delivering three-dimensional virtual content to a user, comprising:
a three-dimensional virtual world hosted by a three-dimensional virtual world host;
a client associated with a virtual plot of land within the three-dimensional virtual world; and
a referencing database hosted by the three-dimensional virtual world host which correlates identifier data for the client with identifier data for the virtual plot of land;
wherein a user requests three-dimensional virtual content relating to the virtual plot of land from the three-dimensional virtual world host,
the three-dimensional virtual world host responds by supplying the user with identifier data from the referencing database for the client associated with the virtual plot of land,
the user contacts the client using the identifier data and requests the three-dimensional virtual content, and
the client transmits the requested three-dimensional virtual content to the user.

2. The system of claim 1, wherein the three-dimensional virtual world is a digital virtual world made up of two-dimensional and three-dimensional graphical data describing a three-dimensional virtual space.

3. The system of claim 2, wherein the three-dimensional virtual space includes plots of virtual land assigned to clients.

4. The system of claim 3, wherein users connect to the three-dimensional virtual world in order to access the plots of virtual land and their respective three-dimensional virtual content.

5. The system of claim 1, wherein the three-dimensional virtual content is data relating to the makeup of the three-dimensional virtual world's two-dimensional and three-dimensional images, models, or shapes.

6. The system of claim 5, wherein the three-dimensional virtual content is at least one of color, material, texture, opacity, or reflectiveness.

7. The system of claim 1, wherein the identifier data stored on the referencing database are the grid coordinates of the plot of virtual land and the Internet Protocol address of the client computer system associated with the plot of virtual land.

8. The system of claim 1, wherein users locally store at least some of the referencing database in order to decrease network traffic for the three-dimensional virtual world host.

9. A method for delivering three-dimensional virtual content to a user, comprising:
hosting a three-dimensional virtual world on a three-dimensional virtual world host;
hosting a referencing database on the three-dimensional virtual world host;
associating a client with a virtual plot of land within the three-dimensional virtual world;
correlating identifier data for the client with identifier data for the virtual plot of land within the referencing database;
receiving a request from a user for three-dimensional virtual content relating to the virtual plot of land;
supplying the user with identifier data from the referencing database for the client associated with the virtual plot of land;
allowing the user to contact the client using the identifier data and request the three-dimensional virtual content; and
allowing the client to transmit the requested three-dimensional virtual content to the user.

10. The method of claim 9, further comprising allowing users to locally store at least some of the referencing database in order to decrease network traffic for the three-dimensional virtual world host.

11. The method of claim 9, wherein the three-dimensional virtual world is a digital virtual world made up of two-dimensional and three-dimensional graphical data describing a three-dimensional virtual space.

12. The method of claim 11, wherein the three-dimensional virtual space includes plots of virtual land assigned to clients.

13. The method of claim 12, wherein users connect to the three-dimensional virtual world in order to access the plots of virtual land and their respective three-dimensional virtual content.

14. The method of claim 9, wherein the three-dimensional virtual content is data relating to the makeup of the three-dimensional virtual world's two-dimensional and three-dimensional images, models, or shapes.

15. The method of claim 14, wherein the three-dimensional virtual content is at least one of color, material, texture, opacity, or reflectiveness.

16. The method of claim 9, wherein the identifier data stored on the referencing database are the grid coordinates of the plot of virtual land and the Internet Protocol address of the client computer system associated with the plot of virtual land.
